(19) United States
(12) Patent Application Publication
(10) Pub. No.: US 2007/0125245 A1
(43) Pub. Date: Jun. 7, 2007

(54) Method and apparatus for producing calendering paper

(76) Inventors: Pekka Linnonmaa, Helsinki (FI); Hannu Latti, Vantaa (FI); Markku Kyytsonen, Numminen (FI)

Correspondence Address: STIENNON & STIENNON, 612 W. MAIN ST., SUITE 201, P.O. BOX 1667, MADISON, WI, 53701-1667, US

(21) Appl. No.: 10/598,664

(22) PCT Filed: Mar. 11, 2005
(86) PCT No.: PCT/FI05/50076

§ 371 Date: Oct. 27, 2006

Related U.S. Application Data
(60) Provisional application No. 60/552,936, filed on Mar. 12, 2004.

(51) Int. Cl. B30B 15/34

(52) U.S. Cl. 100/331; 100/161; 100/38

(57) ABSTRACT

A paper web moistened in a paper machine and reeled on a machine reel is calendered in a multinip calender arranged apart from the paper machine, whose roll assembly is formed of a first set of rolls and a second set of rolls in the travel direction of the paper web. At least one surface of the paper web is moistened with at least one pre-moisturizer, whereafter the paper web is guided to the first calender nip of the first set of rolls and one surface of the paper web is moistened with at least one intermediate moisturizer, whereafter the paper web is guided to the first calender nip of the second set of rolls, wherein a paper web having a roughness of 1.0-1.1 μm and/or gloss of 54-57% or 56-60% is produced as a result of calendering.

### FIELD OF THE INVENTION

The invention relates to a method according to the preamble of the appended claim 1 for producing calendered paper. The invention also relates to an apparatus for implementing the aforementioned method in accordance with the preamble of the appended claim 16.

### BACKGROUND OF THE INVENTION

After the drying of paper, the desired surface structure of the web is produced by means of a mechanical treatment of the surface of paper, i.e. calendering. There are many calendering methods, but it is characteristic to all of them that the web is led through one or several nips, which is/are formed between two rotating rolls that are pressed against each other. The purpose of the calendering is to improve the properties of a paper web, especially its thickness profile, smoothness, gloss as well as porosity and opacity of the surface. The formability of the paper web in the nip is affected by the temperature of the calender rolls, the nip pressure prevailing in the nip and the moisture content of the web. By adjusting these parameters it is possible to affect the above-mentioned physical properties of the paper web.

At present, the end users of paper demand paper grades of higher quality. The speeds of paper machines have also increased, which has resulted in rapid development of on-line calendering methods. However, on-line calendering methods are not suitable for production of high quality printing paper grades with especially high surface quality requirements, such as SC grades. These high quality paper grades must still be produced by using re-reeling and off-line multiroll or super calenders after the drying of the fiber web, wherein several, even three or four such calenders are used in parallel in one paper machine to satisfy the production capacity.

Supercalenders are calendering units in which nips are formed between a press roll having a smooth surface, such as a metal roll, and a roll provided with a flexible coating, such as a paper or polymer roll. Supercalenders typically comprise 10 to 12 nips of which one is a so-called reversing nip in which two rolls having a flexible surface are positioned against each other. By means of the reversing nip it is possible to treat both sides of the web to make them substantially similar. The supercalender rolls are conventionally arranged on top of each other, wherein they form a high stack of rolls.

Conventionally, SC grades are manufactured in such a manner that the paper is dried, “overdried” to a moisture content of approximately 2 to 4% in the drying section of the paper machine. Thereafter the paper is moistened to caledering moisture of 8 to 11% before reeling up. On the reel, the moisture of the paper has time to stabilize in the z-direction of paper before supercalendering by means of the supercalender.

However, the moistening of paper to the above-mentioned moisture content causes problems. It is difficult to reel up such paper having a moisture content of 8 to 11% and to handle the paper reels as well. Problems are also caused by the shrinking of the web in the CD and/or MD direction resulting from the drying of the paper before calendering. The height of the stack of rolls in the supercalender sometimes also causes problems relating to space in a paper mill.

Normally, when paper is calendered the smoothening and glazing of its surface takes place at the expense of the thickness of paper. In the calender, linear load and/or nip pressure are/is used as a control variable, which determines the surface quality of the paper as well as the final thickness. In other words, when the aim is to attain good surface quality, the thickness of paper is reduced. Attempts have been made to solve this problem by means of so-called gradient calendering, in which paper is moistened right before calendering in such a manner that the moistening water has time to be absorbed only in the surface of the paper web, wherein the effect of calendering is exerted only on the surface layers of the web, and the calendering does not bring about changes in the density of the central parts of the web or a substantial change in the thickness of the web.

Gradient calendering has been applied in on-line calenders in which the paper web is guided directly without re-reeling from the drying section of the paper machine to a calender containing several nips, for example to a supercalender. Such a method is disclosed for example in the U.S. Pat. No. 6,401,355, in which the web is overdried in the drying section of the paper machine and moistened again before it is guided to an on-line calender located in connection with the paper machine. The amount of moistening water and the absorption time of the water is selected in such a manner that the moistening water only affects the surface layers of the web. In the U.S. Pat. No. 6,758,135 one side of the paper web is moistened with a first moisturizer before the web is guided to a supercalender, and the opposite side is moistened with a second moisturizer after the reversing nip of the supercalender. U.S. Pat. No. 6,698,342 also discloses the use of two moisturizers in connection with the calendering process, in which a multiroll calender is divided into two roll sets of rolls and a first moisturizer is positioned before the calender and a second, a so-called intermediate moisturizer is positioned between the set of rolls.

However, by means of the methods according to these publications it has not been possible to attain the high surface quality required of SC papers. Furthermore, the methods presented by these publications are only suitable for on-line calenders. In practice, moisture gradient calendering has not yet been applied in off-line multinip calenders.

### BRIEF DESCRIPTION OF THE INVENTION

Therefore, the purpose of the present invention is to provide a method for producing calendered paper, which method avoids the above-mentioned problems and in which moisture gradient calendering is applied in an off-line multinip calender.

To attain this purpose, the method according to the invention is primarily characterized in what will be presented in the characterizing part of the independent main claim 1.

The apparatus according to the invention, in turn, is primarily characterized in what will be presented in the characterizing part of the independent claim 16.

The other, dependent claims present some preferred embodiments of the invention.

The invention is based on the idea that a paper web is treated by means of an off-line multinip calender whose roll assembly is formed of two separate sets of rolls in the travel direction of the web, a first set of rolls and a second set of rolls. Before calendering, after the unwinding, the paper web to be treated is moistened with a pre-moisturizer to a moisture content of 8 to 12%, before the web is guided to the first calender nip of the first set of rolls 3. The paper web is moistened again by means of an intermediate moisturizer to a moisture content of 6 to 10%, before the web is guided to the first calender nip of the second set of rolls.

Before the paper web is guided to the multinip calender in connection with the web-making process, the paper has been moistened before the reeling up process to a moisture content of 1 to 10%, advantageously 4 to 7%, which is optimal in view of reeling. This makes both the reeling up in the paper machine and the unwinding in the calender easy. Furthermore, in this moisture content the reels are in balance with the ambient air, and therefore the changes in the MD and CD direction during the storage of paper and the transporting from the paper machine to the calender are less significant than the changes in reels moistened conventionally to a moisture content of 8 to 11%.

The pre-moisturizer positioned in the calender is composed of at least one moisturizer positioned between the unwinder of the calender and the first nip of the first set of rolls of the calender. The intermediate moisturizer is positioned between the first and the second set of rolls. The moisturizers are positioned in close proximity of the web, against the surface of the web in such a manner that the moistening medium coming therefrom hits the surface of the web. There may be two pre-moisturizers, one on each side of the web, and they can be positioned on both sides of the paper web, either at the same point against the web, on different sides of the web so that they substantially moisten the same point in the web, or in different locations on the web so that they moisten different points in the web.

The pre-moisturizers and intermediate moisturizers can be positioned asymmetrically at different points in the web with respect to each other so that the absorption time of the moistening water is substantially the same on both sides of the web. The absorption time indicates the time that it takes the web to move from the center line of the moisturizer extending across the width of the web to the first nip affecting said moistened side of the web. Thus, the moistened side of the web is brought against the surface of the heated roll. By using asymmetrically positioned moisturizers it is possible to attain the same absorption time of the moistening medium on both sides of the web. The absorption time is under 1.5 seconds, typically under 1 second.

The medium used in the moistening can be liquid, such as water, or vapour. If desired, it is also possible to use solutions of water-chemical mixtures. It is possible to select the composition of the solution in such a manner that it intensifies the effect of the moisture gradient technique and improves the properties of paper, such as brightness, opacity, surface strength, dimensional stability and moldability of the paper web and reduces the fouling of the calender rolls.

In web moistening it is possible to use any moistening devices suitable for this purpose, but it is most advantageous to use moisturizers having nozzles whose droplet size is under 100 μm. The moistening devices extend across the width of the web in such a manner that the entire width of the web is moistened. When desired, it is possible to use the moistening devices also for profiling of the web, wherein only some of the nozzles positioned across the width of the web are used for the moistening.

The moistening is adjusted by means of feedback control in which multivariable control and/or model-based predictive control are/is utilized. For the adjustment, the moisture of the paper web moving in the calender or another property of the same, such as roughness, gloss, porosity, brightness and opacity is measured either by fixed-point measurement sensors or scanning measurement sensors travelling back-and forth across the width of the web. The sensors are typically attached to a measurement beam extending across the width of the web, and there may be one or several such beams in the calender.

By means of the invention, it is possible to apply moisture gradient calendering in off-line multinip calenders. By means of the invention it is possible to reduce the number of calenders per paper machine, even reductions by two calenders are possible, which brings about savings in the investment costs of mills. The invention improves especially the properties of SC papers, especially their roughness and gloss can be raised to a level higher than before.

### BRIEF DESCRIPTION OF THE DRAWINGS

In the following, the invention will be described in more detail with reference to the appended drawings, in which

FIG. 1 shows a schematical side-view of an apparatus according to the invention,

FIG. 2 shows a schematical side-view of a second apparatus according to the invention,

FIGS. 3a and 3b show schematical side-views of the embodiments of placing a pre-moisturizer and an intermediate moisturizer in an apparatus according to the invention,

FIG. 4 shows a side-view of a third apparatus according to the invention,

FIG. 5 shows a side-view of a fourth apparatus according to the invention,

FIG. 6 shows a side-view of a fifth apparatus according to the invention.

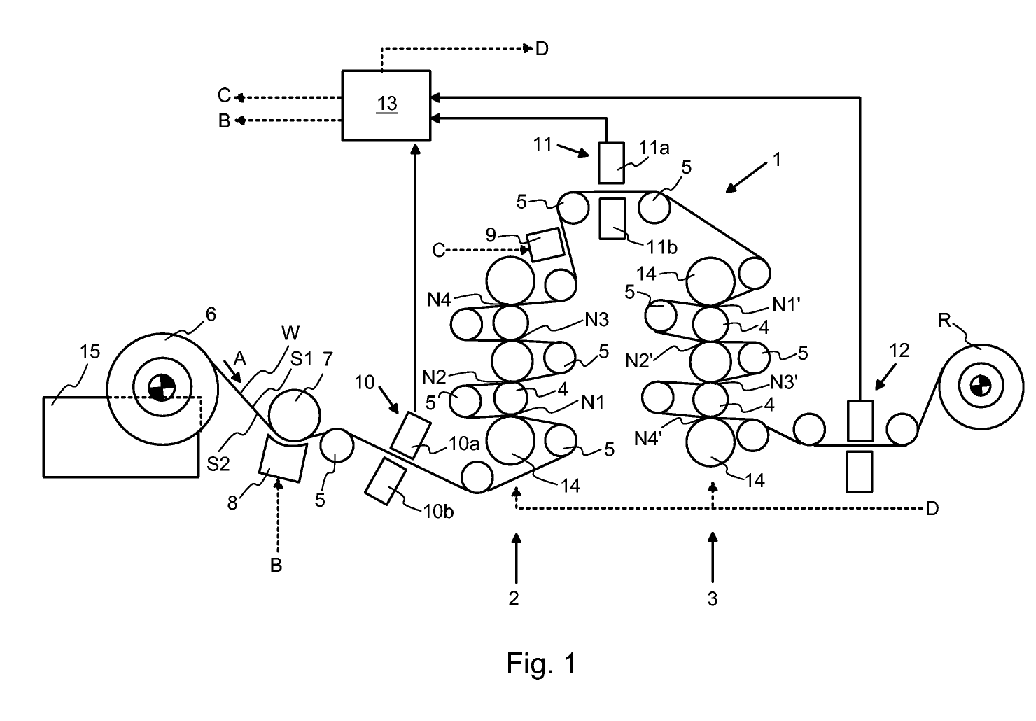

In FIGS. 1a to 6, the same numerals refer to corresponding parts and they will not be explained separately later on, unless required for clarification of the subject matter.

### DETAILED DESCRIPTION OF THE INVENTION

The figures show only a few embodiments of the apparatuses according to the invention. The number of calender nips depends on the quality of paper to be calendered and the running speed of the calender. Table 1 shows advantageous nip numbers to be used for different paper grades.

TABLE 1

| Paper grade | Number of calender nips |
|---|---|
| SC-A/SC-A+ | 4 + 4 or 5 + 5 |
| SC-B | 2 + 4 or 4 + 4 |
| SC-C/ | 2 + 2 or 2 + 4 |
| improved newspaper | |

In the table, the number of calender nips is the number of nips in the first set of rolls+the number of nips in the second set of rolls in a multinip calender.

FIG. 1 shows an apparatus according to the invention, which comprises a multinip calender 1 consisting of two stacks of rolls, i.e. sets of rolls, a first set of rolls 2 and a second set of rolls 3. In both sets of rolls successive nips are formed between the superimposed rolls in the stack of calender rolls. Both sets of rolls 2 and 3 are formed of rolls 14 having a flexible coating, such as paper or polymer rolls, heated metal rolls 4 having a smooth surface following each other alternately in the machine direction, and reversing and guide rolls 5 guiding the travel of paper web in the calender. The successive nips in the calender that affect the properties of the surface of the web are thus always formed between a roll 14 having a flexible shell and a heated roll 4 having a rigid shell.

The paper web W to be calendered is brought in the form of rolls 6 to an unwinder 15 belonging to the calendering process. The paper web has been moistened in the paper machine before the reeling up of the reel 6 to an optimal moisture content of 1 to 10%, advantageously 4 to 7%. From the reel 6 the web W is run in the direction of the arrow A to be moistened by means of the pre-moisturizer 8 before it is guided via guiding rolls 5 to the first nip N1 of the first set of rolls 2 of the multinip calender. In this embodiment of the invention the nip N1 is the lowermost nip in the set of rolls 2. From the nip N1 the web runs around the reversing roll 5 to the next upper nip N2. Thereafter the paper web travels around the reversing roll 5 and through the nip N3 and forward, until the web has been passed through the uppermost nip N4 of the first set of rolls 2. Thereafter the paper web W is passed via an intermediate moisturizer 9 to the first nip N1′ of the second set of rolls 3, which is the uppermost nip in the second set of rolls 3. Thereafter the web is passed around the reversing roll to the next lowermost nip N2′, and further by means of the reversing rolls 5 to the nips N3′ and N4′. The nip N4′ is the lowermost nip in the second set of rolls 3, whereafter the web is run guided by the guide rolls 5 to be reeled into a full reel R.

The moisturizers, the pre-moisturizer 8 and the intermediate moisturizer 9 in the apparatus are positioned in close proximity of the surface of the web, against it in such a manner that the moistening medium sprayed from the moisturizer meets the surface of the web. The pre-moisturizer 8 is positioned in such a manner that the moistening of the web takes place when the web is supported against a supporting roll 7, wherein the web W is thus moistened only from one side S2 that is positioned against the pre-moisturizer 8. The pre-moisturizer is positioned in relation to the web in such a manner that the side of the web that has been moistened in the pre-moisturizer 8 ends up in contact with the heated thermoroll 4 having a hard surface in the first nip N1 of the first set of rolls. The intermediate moisturizer 9 is positioned after the first set of rolls 2 in such a manner that it moistens the other surface S1 of the web in the free draw before the web W is passed to the first nip N1′ of the second set of rolls in the multinip calender. The moisturizers 8 and 9 are positioned in relation to the web in such a manner the absorption time of the moistening water into the web is substantially the same on both sides of the web. The accurate location of the moisturizers is determined in accordance with the desired absorption time.

For the purpose of controlling the apparatus it is provided with a control unit 13 that controls the amount of moistening medium supplied by the moisturizers 8 and 9, and the nip pressures of the calender, as well as the temperature and profiles of the heated rolls 14. The control unit contains the calculation and control algorithms required by the control.

In the control, feedback control utilizing multivariable control and/or model-based predictive control is used. For the control the apparatus comprises measurement devices 10 and 11 for measuring the moisture content of the web, being positioned after the pre-moisturizer 8 and the intermediate moisturizer 9. The measurement devices are composed of measuring heads 10a, 10b, 11a and 11b positioned on both sides of the web, substantially at the same point of the web. The measuring heads are attached to a measurement beam (not shown in the figure) extending across the width of the web in which they travel back and forth, measuring the web continuously. The moisture data measured by the measurement devices 10 and 11 is transmitted to the control unit 13 that calculates the control signals B and C necessary for adjusting the amount of moistening medium from the moisture data, and transmits them to the moisturizers 8 and 9. The apparatus is also provided with a third measurement device 12 positioned after the multinip calender 1, before the reeling of the calendered web, said measurement device measuring at least the caliper and gloss of the web. These measurement results are used for controlling the multinip calender 1. In other words, the values measured by the measurement device 12 are transmitted to the control unit 13 that calculates the necessary control signals D by means of which the nip pressures of the nips in the multinip calender 1 and the temperature of the heated rolls 14 are adjusted. The measurement of the different properties of the paper web and the measurement devices used in the measurements are known as such by a person skilled in the art, and therefore they are not described in more detail in this context.

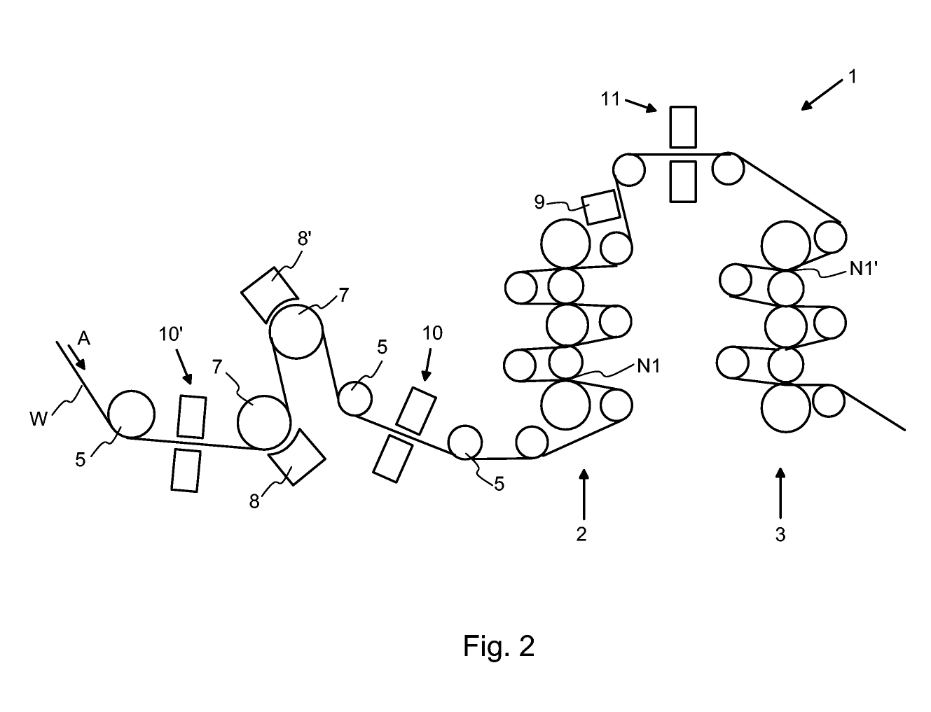

FIG. 2 shows an apparatus comprising a multinip calender 1 composed of two sets of rolls, similar to the one shown in FIG. 1. In this embodiment, the apparatus comprises two pre-moisturizers 8 and 8′, which moisten both sides of the web before the web is passed to the first nip N1 of the first set of rolls 2 of the multinip calender 1. Both pre-moisturizers are arranged to moisten the web supported by supporting rolls 7. The apparatus also contains an intermediate moisturizer 9 positioned after the first set of rolls 2 of the multinip calender in such a manner that it moistens the second surface of the web before the web W is passed to the first nip N1′ of the second set of rolls 3 in the multinip calender.

For the purpose of adjusting the apparatus the apparatus comprises a measurement device 10′ positioned before the first pre-moisturizer 8 in the travel direction of the web, said measurement device measuring the moisture content of the web before the pre-moisturizers 8 and 8′ Furthermore, the apparatus comprises a measurement device 10 arranged to measure the moisture content of the web after the pre-moisturizers 8 and 8′, and a measurement device 11 that measures the moisture content of the web after the intermediate moisturizer 9. The moisture data of the web obtained from the above-mentioned measurement devices is used for controlling the moisturizers 8, 8′ and 9. In the control of the moisturizers a control unit (not shown in the figure) is used, as shown in FIG. 1.

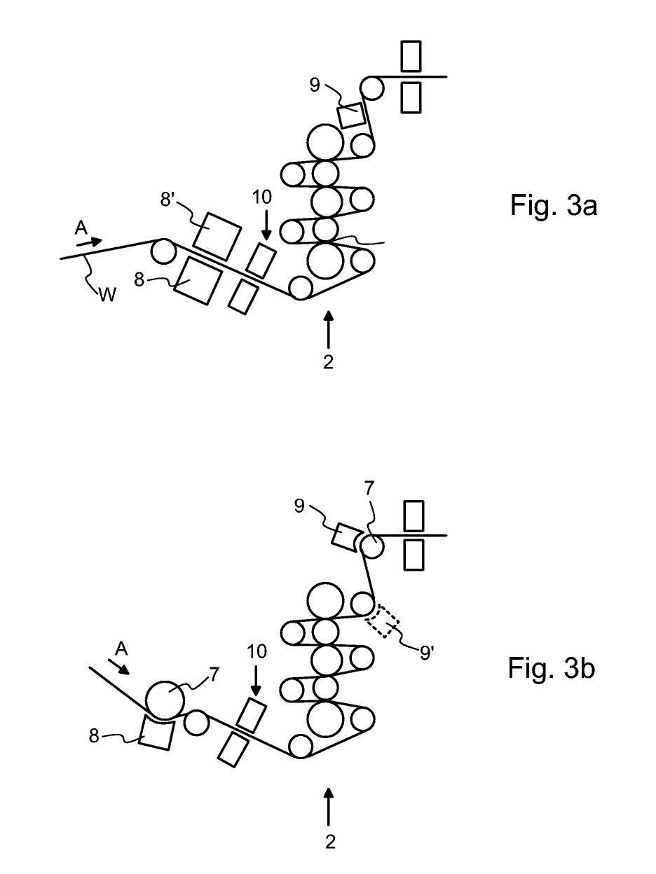

As disclosed above, the moisturizers can be arranged in the apparatus in such a manner that they moisten the web either when it is supported against a suitable supporting surface, such as a supporting roll, or when the web travels without support. As a supporting surface it is also possible to use a supporting plate installed in a suitable manner. FIGS. 3a to 3b show two alternative ways of positioning the pre-moisturizers and intermediate moisturizers in the multinip calender. In FIG. 3a, two pre-moisturizers 8 and 8′ are positioned on both sides of the web W before the first nip N1 of the first set of rolls 2 of the multinip calender in such a manner that they moisten substantially the same point of the web. The intermediate moisturizer 9 positioned after the first set of rolls 2 moistens one side of the web. In FIG. 3b the intermediate moisturizer 9 is positioned after the first set of rolls 2 to moisten the web W supported against the supporting roll 7. The premoistening of the web takes place by means of one pre-moisturizer 8 that moistens the opposite side of the web. If desired, the intermediate moisturizer can be positioned to moisten the same side of the web supported by a supporting roll as the pre-moisturizer 8. Such an intermediate moisturizer 9′ is drawn in broken lines in FIG. 3b. It is also possible to use both intermediate moisturizers 9 and 9′ for moistening the web.

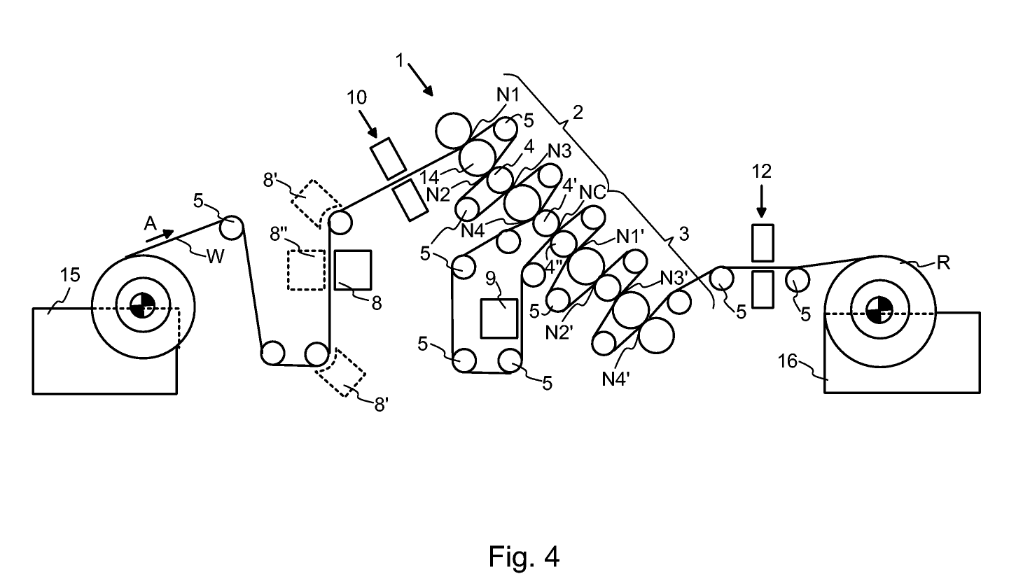

FIG. 4 shows an embodiment of the invention in which a multinip calender 1 having 9 nips is arranged in a slightly oblique position with respect to the horizontal plane. By means of this arrangement it is possible to reduce the height of the multinip calender and it can be placed in a lower mill hall than a calender installed in an upright position. The multinip calender 1 is formed in such a manner that it comprises two sets of rolls, a first set of rolls 2 and a second set of rolls 3 that are arranged successively in such a manner that the lower roll 4′ of the first set of rolls and the upper roll 4″ of the second set of rolls form a shared nip NC between the sets of rolls. The web W is unwound from the reel 6 by means of an unwinder 15, and passed by means of guide rolls 5 to be moistened by means of the pre-moisturizer 8 before it is guided to the first, uppermost nip N1 of the first set of rolls 2 of the multinip calender 1. From the nip N1 the web is passed around the reversing roll 5 to the next lower nip N2. Thereafter the paper web runs around the reversing roll 5 and through the nip N3 and forward, until the web has been passed through the lowermost nip N4 of the first set of rolls 2. After the nip N4 the paper web W is passed via the guide rolls 5 to be moistened by the intermediate moisturizer 9. Thereafter the web is passed via the nip NC shared by the sets of rolls 2 and 3 and formed by the lowermost roll 4′ of the first set of rolls 2 and the uppermost roll 4″ of the second set of rolls 3 to the first nip N1′ of the second set of rolls 3, which is the uppermost nip of the second set of rolls 3. Thereafter the web is passed around the reversing roll 5 to the next lower nip N2′, and further by means of the reversing rolls to the nips N3′ and N4′. After the nip N4′ the paper web W is passed via the guide rolls 5 to be reeled by the reel-up 16 to form a full reel R.

The pre-moisturizer 8 and the intermediate moisturizer 9 are positioned in such a manner that they both moisten different sides of the web and that the absorption time of the moistening medium into the web is substantially the same on both sides of the web. It is, of course, possible to position pre-moisturizers and intermediate moisturizers in the apparatus so that they also moisten the web travelling against the roll, as shown by pre-moisturizers 8′ drawn in broken lines. It is also possible to moisten both sides of the web substantially at the same point by using two pre-moisturizers, a pre-moisturizer 8 drawn in solid lines and a pre-moisturizer 8′ drawn in broken lines.

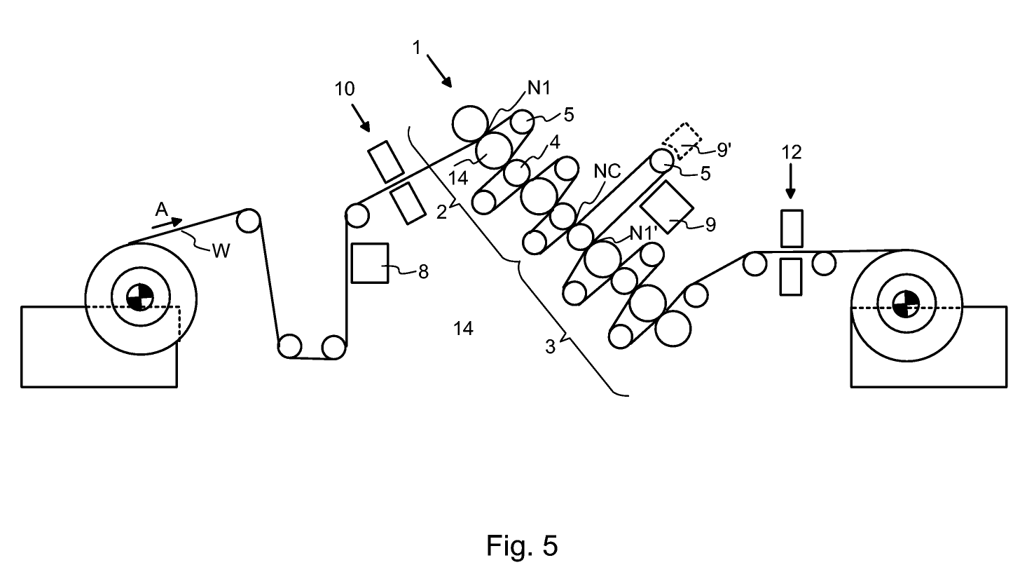

FIG. 5 also shows an embodiment of the invention in which the first set of rolls 2 and the second set of rolls 3 forming the multinip calender 1 are arranged successively in such a manner that they form a shared nip NC between the sets of rolls. The multinip calender 1 is arranged in an oblique position in this embodiment as well. The web W is passed via the pre-moisturizer 8 to the first nip N1 of the first set of rolls 2 of the multinip calender 1, and further therefrom through the first set of rolls, and further through the shared nip NC between the first set of rolls 2 and the second set of rolls 3. Thereafter the web is passed around the reversing roll 5 to be moistened by the intermediate moisturizer 9, and further therefrom under the guidance of the reversing rolls 5 through the second set of rolls 3.

The pre-moisturizer 8 and the intermediate moisturizer 9 are positioned in such a manner that they both moisten different sides of the web. It is also possible to position the intermediate moisturizer in the apparatus so that it also moistens the web travelling against the roll, as shown by the pre-moisturizer 9′ drawn in broken lines. In this embodiment, the intermediate moisturizer 9 is positioned in such a manner that the absorption time of the moistening medium sprayed into the web is shorter than that shown in the embodiment of FIG. 4.

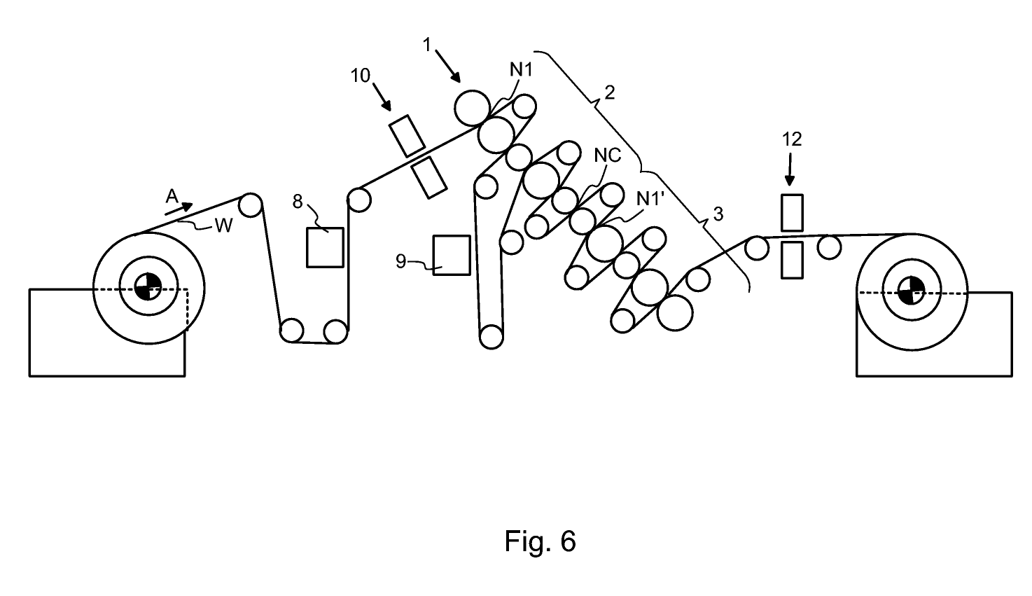

FIG. 6 shows an embodiment of the apparatus according to the invention. The web is moistened with a pre-moisturizer 8 before it is passed to the first nip N1 of the first set of rolls 2 in the multinip calender 1. The intermediate moisturizer 9 is positioned in such a manner that it moistens the web W after the second nip N2 of the first set of rolls 2.

For the purpose of adjusting the calender of the embodiments shown in FIGS. 4 to 6, the apparatus comprises measurement devices 10 that measure the moisture content of the web after premoistening, before the web is passed to the first nip N1 of the first set of rolls 2. The apparatus also comprises a measurement device 12 positioned after the multinip calender 1 for measuring the properties of the web. The measurement results obtained from the measurement devices are transmitted to the control unit of the calender (not shown in the figure), in which control signals necessary for controlling the calender are formed thereof in a manner described hereinabove.

The advantages attained by means of the invention can be found in the following table 2, which illustrates the improvement of the properties of SC-A paper calendered by means of a off-line multinip calender utilizing the gradient calendering process according to the invention when compared to similar SC-A paper (reference) having the same basis weight and other properties, but which has boon calendered with an off-line calender of prior art.

TABLE 2

| | | 1 pre-moisturizer | 2 pre-moisturizers |
|---|---|---|---|
| | | and | and |
| Paper | | 1 intermediate | 1 intermediate |
| property | Reference | moisturizer | moisturizer |
| Roughness (μm) | 1.0-1.1 | 1.0-1.1 | 1.0-1.1 |
| Gloss (%) | 48-50 | 54-57 | 56-60 |
| Blackening | 48-58 | 46-54 | 44-53 |
| Oil absorption (g/m²) | 4.5-6 | 3.5-5 | 3-4.5 |
| Porosity (ml/min) | 15-25 | 10-20 | 7-16 |
| Brightness (%) | 68 | 68 | 68 |
| Opacity (%) | 91 | 91 | 91 |

As can be seen in the Table 2, by means of a method and an apparatus according to the invention it is possible to attain significant improvements in view of gloss, blackening, oil absorption and porosity of paper, when compared to the reference.

The heated rolls, so-called thermorolls used in the multinip calender according to the invention can be made of any material suitable for the purpose, preferably they are made of cast steel or forged stool, which endure well the thermal load exerted thereto by the moistened paper. The temperature the heated rolls that treat the surface of the web that is positioned against the roll and moistened before the calendering nip, should be at least 120° C.

The invention is not intended to be limited to the embodiments presented as examples above, but the invention is intended to be applied widely within the scope of the inventive idea as defined in the appended claims. Thus, it is also possible to form the multinip calender of superimposed calender rolls in such a manner that the travel direction of the web is from top to bottom in the first set of rolls 2 and/or in the second set of rolls 3. Furthermore, the number of pre-moisturizers and intermediate moisturizers disclosed in FIGS. 1 to 6 and their placement with respect to the paper web do not in any way restrict the scope of protection of the invention, but they can be selected according to the paper grade to be manufactured.

1-30. (canceled)

31. A method for producing calendered paper by means of an off-line calender, in which method a paper web manufactured and moistened in a paper machine and reeled on a machine reel is calendered in a multinip calender arranged apart from the paper machine, said paper web (W) being moistened with at least one premoisturizer before the multinip calender and said multinip calender being formed of rolls having a flexible coating and heated rolls placed alternately against each other in such a manner that a nip is formed between successive rolls,
wherein
the paper web is calendered in the multinip calender whose roll assembly is formed of a first set of rolls and a second set of rolls in the travel direction of the paper web;
at least one surface of the paper web is moistened with the at least one pre-moisturizer, whereafter the paper web is passed to the first calender nip of the first set of rolls and the other surface of the paper web is moistened with at least one intermediate moisturizer, whereafter the paper web is guided to the first calender nip of the second set of rolls; and that
the at least one pre-moisturizer and the at least one intermediate moisturizer are positioned in the travel direction of the paper web on the opposite sides of the web in such a manner that the absorption time of the moistening medium sprayed by at least one pre-moisturizer and intermediate moisturizer on the opposite surfaces of the paper web is substantially the same, wherein as a result of calendering a paper web having roughness of 1.0-1.1 μm and/or gloss of 54-57% or 56-60% is produced.

32. The method according to claim 31, wherein one surface of the paper web is moistened before the paper web is passed to the first calender nip of the first set of rolls, and the opposite surface of the paper web is moistened before the paper web is guided to the first calender nip of the second set of rolls.

33. The method according to claim 31, wherein both surfaces of the paper web are moistened before the paper web is guided to the first calender nip of the first set of rolls, and one surface of the paper web is moistened before the paper web is passed to the first calender nip of the second set of rolls.

34. The method according to claim 31, wherein at least one surface of the paper web is moistened when the paper web is supported against a supporting roll or a guide roll.

35. The method according to claim 31, wherein at least one surface of the paper web is moistened when the paper web travels in a free draw.

36. The method according to claim 31, wherein the paper web is guided to the first calender nip of the first set of rolls and to the first calender nip of the second set of rolls, which calender nips are arranged in such a manner that the surface of the paper web moistened by means of at least one pre-moisturizer and/or intermediate moisturizer is pressed against the heated roll in the nip.

37. The method according to claim 31, wherein the paper web is calendered in the multinip calender in which the first set of rolls and the second set of rolls are arranged in separate stacks of rolls.

38. The method according to claim 31, wherein the paper web is calendered in the multinip calender in which the first set of rolls and the second set of rolls are arranged successively in a way that they share one roll nip.

39. The method according to claim 31, wherein the moistening of the paper web and the multinip calender are controlled by means of a control unit.

40. The method according to claim 39, wherein the moisture content of the paper web is measured and the supply of moistening medium of at least one pre-moisturizer and/or intermediate moisturizer is adjusted on the basis of a control signal determined from the moisture data of the paper web.

41. The method according to claim 39, wherein the moisture content and/or gloss of the paper web are/is measured and the nip pressures of the nips of the multinip calender and the temperature of the heated rolls are adjusted on the basis of a control signal determined from the moisture and gloss data of the paper web.

42. The method according to claim 31, wherein the paper grade to be calendered is selected from the following group: SC-A, SC-A+ or SC-B.

43. The method according to claim 42, wherein SC-A or SC-A+ paper is calendered, wherein the multinip calender is formed in such a manner that the first set of rolls and the second set of rolls comprise four nips or the first set of rolls and the second set of rolls comprise five nips.

44. The method according to claim 42, wherein SC-B paper is calendered, wherein the multinip calender is formed in such a manner that the first set of rolls and the second set of rolls comprise five nips.

45. An apparatus for producing calendered paper by means of an off-line calender, said apparatus comprising:
an unwinder for unwinding a paper web produced and moistened in a paper machine and reeled on a machine reel;
a multinip calender formed of rolls having a flexible coating and heated rolls placed alternately against each other in such a manner that a nip is formed between successive rolls;
at least one pre-moisturizer for moisturizing at least one surface of the paper web before the multinip calender;
at least one guide roll;
a reel-up for reeling up the calendered paper web;
wherein
the rolls having a flexible coating and the heated rolls forming the multinip calender are arranged in such a manner that they form a first set of rolls and a second set of rolls in the travel direction of the web;
the at least one pre-moisturizer is arranged to moisten at least one surface of the paper web before guiding the paper web to the first calender nip of the first set of rolls; and that the apparatus comprises at least one intermediate moisturizer for moistening the other surface of the paper web before guiding the paper web to the first calender nip of the second set of rolls; and
the at least one pre-moisturizer and the at least one intermediate moisturizer are positioned in the travel direction of the paper web on the opposite sides of the web in such a manner that the absorption time of the moistening medium sprayed by at least one pre-moisturizer and intermediate moisturizer on the opposite surfaces of the paper web is substantially the same, wherein the roughness of the paper web produced as a result of calendering is 1.0-1.1 μm and/or the gloss is 54-57% or 56-60%.

46. The apparatus according to claim 45, wherein at least one pre-moisturizer is arranged to moisten one surface of the paper web before the paper web is passed to the first calender nip of the first set of rolls, and at least one intermediate moisturizer is arranged to moisten the opposite surface of the paper web before the paper web is passed to the first calender nip of the second set of rolls.

47. The apparatus according to claim 45, wherein at least one pre-moisturizer is arranged to moisten both surfaces of the paper web before the paper web is passed to the first calender nip of the first set of rolls, and at least one intermediate moisturizer is arranged to moisten one surface of the paper web before the paper web is passed to the first calender nip of the second set of rolls.

48. The apparatus according to claim 45, wherein the apparatus comprises at least one supporting roll and that at least one surface of the paper web is arranged to be moistened when the paper web is supported against a supporting roll or a guide roll.

49. The apparatus according to claim 45, wherein at least one surface of the paper web is arranged to be moistened when the paper web travels in a free draw.

50. The apparatus according to claim 45, wherein the first calender nip of the first set of rolls and the first calender nip of the second set of rolls are arranged in such a manner that the surface of the paper web moistened by means of at least one pre-moisturizer and/or intermediate moisturizer is pressed against the heated roll in the nip.

51. The apparatus according to claim 45, wherein the first set of rolls and the second set of rolls are arranged in separate stacks of rolls.

52. The apparatus according to claim 45, wherein the first set of rolls and the second set of rolls are arranged successively so that they share one roll nip.

53. The apparatus according to claim 45, wherein the apparatus comprises a control unit for controlling the moistening of the paper web and the multinip calender.

54. The apparatus according to claim 53, wherein the apparatus comprises measurement devices for measuring the moisture content of the paper web and that the control unit is arranged to determine a control signal from the moisture data of the paper web for adjusting the supply of moistening medium of at least one pre-moisturizer and/or intermediate moisturizer.

55. The apparatus according to claim 53, wherein the apparatus comprises a measurement device for measuring the moisture and/or gloss of the paper web and that the control unit is arranged to determine a control signal from the moisture and gloss data of the paper web to adjust the nip pressures of the nips of the multinip calender and the temperature of the heated rolls.

56. The apparatus according to claim 45, wherein the apparatus is arranged to calender a paper grade selected from the following group: SC-A, SC-A+ or SC-B.

57. The apparatus according to claim 56, wherein the apparatus is arranged to calender SC-A or SC-A+ paper, wherein the multinip calender is formed in such a manner that the first set of rolls and the second set of rolls comprise four nips or the first set of rolls and the second set of rolls comprise five nips.

58. The apparatus according to claim 56, wherein the apparatus is arranged to calender SC-B paper, wherein the multinip calender is formed in such a manner that the first set of rolls and the second set of rolls comprise five nips.
